(19) United States
(12) Patent Application Publication
(10) Pub. No.: US 2011/0145723 A1
(43) Pub. Date: Jun. 16, 2011

(54) SYSTEM AND METHOD FOR REDIRECTING CLIENT-SIDE STORAGE OPERATIONS

(75) Inventors: Richard J. Walsh, Raleigh, NC (US); Alfredo C. Issa, Apex, NC (US)

(73) Assignee: OTO TECHNOLOGIES, LLC, Raleigh, NC (US)

(21) Appl. No.: 12/639,287

(22) Filed: Dec. 16, 2009

(51) Int. Cl. G06F 12/00; G06F 3/00

(52) U.S. Cl. 715/745; 711/112; 711/E12.001

(57) ABSTRACT

A method and system for redirecting client-side storage operations to a remote storage device. A user agent module executing on a client device receives a hypertext transfer protocol (HTTP) message that includes a client-side storage operation directed to a client storage device. The user agent module detects the client-side storage operation and accesses defined criteria to identify one or more remote storage devices on which to implement the remote storage device in lieu of the client storage device. The user agent module then implements the client-side storage operation on the remote storage device.

### FIELD OF THE INVENTION

The present invention relates to data storage and, in particular, to redirecting client-side storage operations to remote storage devices.

### BACKGROUND OF THE INVENTION

It is common for a web site to store information on a client device. Cookies are one example of such client-side storage. Cookies retain information generated by a web site while the web site is being accessed by a user. An example of data that may be stored in a cookie is user account information, such as a user identifier and password, which may be used by a web site to automatically authenticate the user to the web site without requiring reentry by the user of their respective user identifier and password each time the user navigates to the web site.

Storing data on a client device provides several advantages to a web site. First, physical storage device requirements are decreased by storing data on the client device rather than on a central server maintained by a web site operator. Second, storing data on the client device allows additional processing to be performed by the client device rather than by the web site, improving the scalability of the web site. Accordingly, there is significant interest in utilizing client-side storage among web site developers. Additional client-side storage technologies, such as client-side database storage, are being introduced to help satisfy this interest.

Unfortunately, client-side storage can result in data being spread across multiple devices that may be used by a user to access a web site. For example, the user may access a web site from an Internet-capable phone, such as an iPhone, when shopping, from a home computer when at home, and from a work computer when at work. Information stored in client-side storage will only be available to the device on which the information was stored. For example, items placed into a “wish list” by a user while accessing a web site from a work computer will not be available to the user when they later access the same web site from their home computer. Accordingly, what is needed is a mechanism for redirecting client-side operations to remote storage locations so that data may be accessed by client devices other than the client device to which the web site directed the data.

### SUMMARY OF THE INVENTION

The present invention automatically redirects client-side storage operations to remote storage devices. For example, read and write operations that are directed to a client device are redirected to one or more remote storage devices. In one embodiment, a web service generates a hypertext transfer protocol (HTTP) message and sends the HTTP message toward a user agent executing on a client device. The user agent receives the HTTP message and detects in the HTTP message a client-side storage operation directed to a client storage device. The user agent implements the client-side storage operation on a remote storage device in lieu of the client storage device.

The user agent may access defined criteria to identify a particular remote storage device from a number of potential remote storage devices. The defined criteria may include a type of service provided by the web service, a source address of the web service, a type of data that is the subject of the client-side storage operation, and the like. For example, if the HTTP message relates to an email service, the defined criteria may indicate that the client-side storage operation is to be implemented on an email remote storage device. If the source of the HTTP message is from a particular web site, such as the web site BUY.COM, the defined criteria may indicate that the client-side storage operation is to be implemented on a home server remote storage device.

The client-side storage operation may be, for example, a local storage command, a local session storage command, or a local database storage command. The client-side storage operation may be implemented on one or more remote storage devices.

In one embodiment, the user agent includes a script engine having a pre-processing phase and an execution phase. Upon detection of a script in the HTTP message, the user agent provides the script to the script engine for execution. During an initial pre-processing phase, the script engine identifies client-side storage operations and replaces the client-side storage operations with remote storage operations. The remote storage operations, for example, may invoke a remote storage engine in lieu of a local storage engine. After the pre-processing phase, the script engine performs an execution phase, wherein the script is executed. During the execution phase, the script engine executes the remote storage operations, thereby implementing the client-side storage operations on a remote storage device in lieu of the client storage device. During the pre-processing phase, the user agent may access one or more defined criteria to determine one or more remote storage devices on which the client-side storage operations should be implemented and generate remote storage operations accordingly.

According to another embodiment, the script engine may detect a client-side storage operation while executing the script and implement a remote storage operation in lieu of the client-side storage operation. For example, the user agent may include a local storage engine for implementing client-side storage operations on a client storage device and a remote storage engine for implementing client-side storage operations on remote devices. The script engine may detect in the script an invocation of a function in the local storage engine and invoke a corresponding function in the remote storage engine to implement the client-side storage operation on a remote storage device. The script engine may also access one or more defined criteria to determine one or more remote storage devices on which the client-side storage operations should be implemented and provide such information to the remote storage engine.

According to another embodiment of the invention, the user agent may include a local storage engine for implementing client-side storage operations on a client storage device and a remote storage engine for implementing client-side storage operations on one or more remote storage devices. A script engine may invoke the local storage engine to implement a client-side storage operation on the client storage device. The local storage engine may access one or more defined criteria to determine one or more remote storage devices on which the client-side storage operation should be implemented and call the remote storage engine to implement the client-side storage operation on the one or more remote storage devices in lieu of the local storage device.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 illustrates a block diagram of a system using client-side storage operations for storing data on a client storage device.

FIG. 2 is a block diagram illustrating aspects of one embodiment of the invention.

FIG. 3 is a flow chart illustrating a method for implementing client-side storage operations on a remote storage device according to one embodiment of the invention.

FIG. 4 is a flow chart illustrating a method for implementing client-side storage operations on a remote storage device according to another embodiment of the invention.

FIG. 5 is a flow chart illustrating a method for implementing client-side storage operations on a remote storage device according to another embodiment of the invention.

FIG. 6 is a flow chart illustrating a method for implementing client-side storage operations on a remote storage device according to yet another embodiment of the invention.

FIG. 7 is a block diagram illustrating an exemplary user interface that may be used to define criteria according to one embodiment of the invention.

FIG. 8 illustrates components of an exemplary client device.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

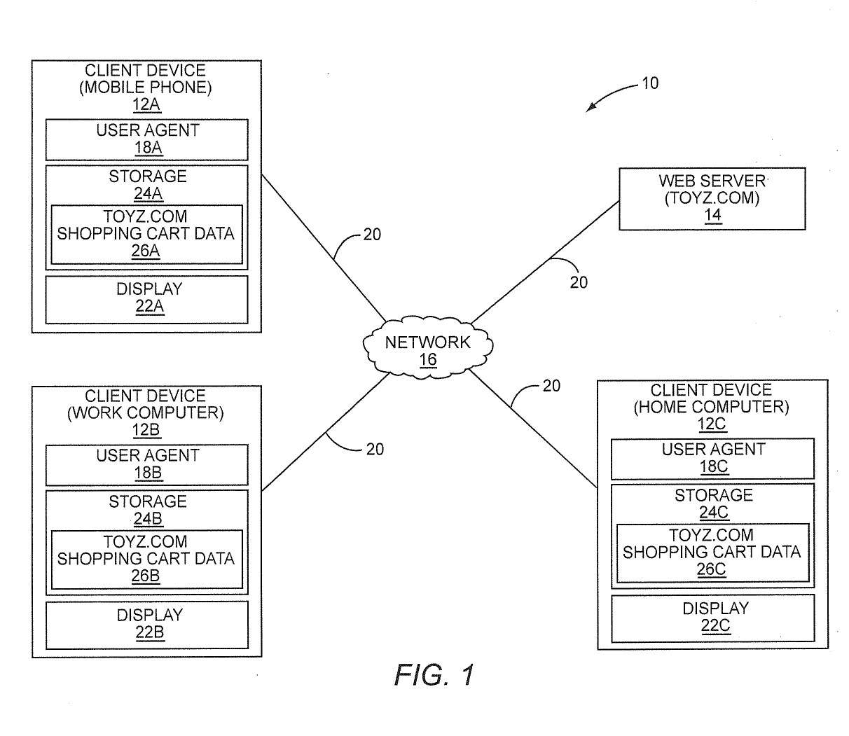

The present invention relates to redirecting client-side storage operations to remote storage devices in lieu of a local storage device. To provide context to the present invention, FIG. 1 illustrates a block diagram of a system 10 using client-side storage operations to store data generated by a web service. The system 10 includes a plurality of client devices 12A-12C which access a web server 14 via a network 16. Any of the client devices 12A-12C may be referred to herein individually as the client device 12, or collectively as the client devices 12 where the discussion may relate generally to any of the client devices 12A-12C. The client device 12 may comprise any type of processing device capable of interacting with the web server 14, including, for example, a mobile phone, a work computer, a home computer, a digital video recorder (DVR), an electronic reader (e.g., an E-reader), and the like. The client devices 12A-12C typically have a user agent module 18A-18C, respectively, executing thereon. The user agent module 18 can comprise any combination of hardware and software modules capable of generating and interpreting messages exchanged with the web server 14. According to one embodiment of the invention, the user agent module 18 comprises a web browser, such as a Safari®, Explorer®, or FireFox® web browser.

The messages exchanged between the web server 14 and the client devices 12 can comprise any suitable message format and protocol capable of communicating the information necessary for the web server 14 to provide a desired web service to the client devices 12. According to one embodiment of the invention, the messages comprise hypertext transfer protocol (HTTP) messages.

The web server 14 may provide any type of web service to the client devices 12, such as, for example, a retail online shopping web service (e.g., the sale of toys via a WWW.TOYZ.COM web site), a document generation and modification web service, an email web service, and the like. Generally, the user agent module 18, such as the user agent module 18A, generates and sends an HTTP message towards the web server 14 in response to input from a user. For example, the user may enter a uniform resource locator (URL) such as WWW.TOYZ.COM in an address window of the user agent module 18A. The phrase “towards” means the HTTP message is being sent to an intended destination. The destination may be identified in the HTTP message, such as via a domain name or an internet protocol (IP) address, for example. In the present example, the HTTP message may contain an IP address identifying the web server 14, and the HTTP message is ultimately delivered to the web server 14 via the network 16 directly or indirectly through one or more intermediate network elements such as routers (not illustrated) and the like. The network 16 can comprise any proprietary or conventional network, or combination thereof, capable of routing messages between processing devices, such as the client devices 12 and the web server 14. Each of the client devices 12 and the web server 14 are coupled to the network 16 via an access link 20, which may comprise any suitable access technology, such as a cable or digital subscriber line (DSL) modem, WiFi, cellular technology, and the like.

In response to the HTTP message from the client device 12A, the web server 14 generates an HTTP response message and sends the HTTP response message towards the client device 12A. The HTTP response message may include a message body portion containing instructions that direct the user agent module 18A to display information on a display 22A. The message body portion may comprise a hypertext markup language (HTML) document, for example. The message body portion may also include one or more client-side storage operations that direct the user agent module 18A to access a client-side storage 24A integral with, or coupled to, the client device 12A. The client-side storage 24A may comprise any suitable storage medium, including, for example, a hard disk drive, a flash drive, a universal storage bus (USB) drive, and the like. The client-side storage operations can comprise any type of conventional or proprietary storage instructions, such as, for example, local storage instructions, session storage instructions, database storage instructions, and the like. The client-side storage operations may comprise a web storage command as defined by the W3C in one or more W3C specification documents, such as the Web Storage W3C Working Draft 29 Oct. 2009, available at www.w3.org, the contents of which are hereby incorporated herein by reference. One example of a type of data that may be stored on the client device 12A is shopping cart data 26A identifying one or more products the user has selected for purchase from the web server 14.

Assume for the purposes of illustration that the user selects a particular product for purchase from the web server 14 via the user agent module 18A. The user agent module 18A generates an HTTP message identifying the product and sends the HTTP message towards the web server 14. The web server 14 receives the HTTP message, generates an HTTP message including client-side storage instructions directing the user agent module 18A to store product identification information identifying the selected product in the client-side storage 24A, and then sends the HTTP message towards the user agent module 18A via the client device 12A. The client device 12A provides the HTTP message to the user agent module 18A, which executes the client-side storage instructions and stores the product identification information in the client-side storage 24A. For purposes of illustration, assume the user is interrupted and is unable to complete the purchase at that time.

Assume further that the user later accesses the web server 14 via the client device 12C while at home. While the client-side storage 24C similarly contains shopping cart data 26C, the shopping cart data 26C does not contain the product identification information previously stored in the shopping cart data 26A, because the client-side storage operations previously generated by the web server 14 were directed to the client device 12A, not the client device 12C. This example illustrates one problem with client-side storage inherent in many web services; the information stored on a client device 12, such as the client device 12A, is not easily, or perhaps not at all, accessible by other client devices 12, such as the client devices 12B and 12C. Thus, the user must repeat on the client device 12C the steps that were previously performed on the client device 12A to identify and select the desired product from the web server 14.

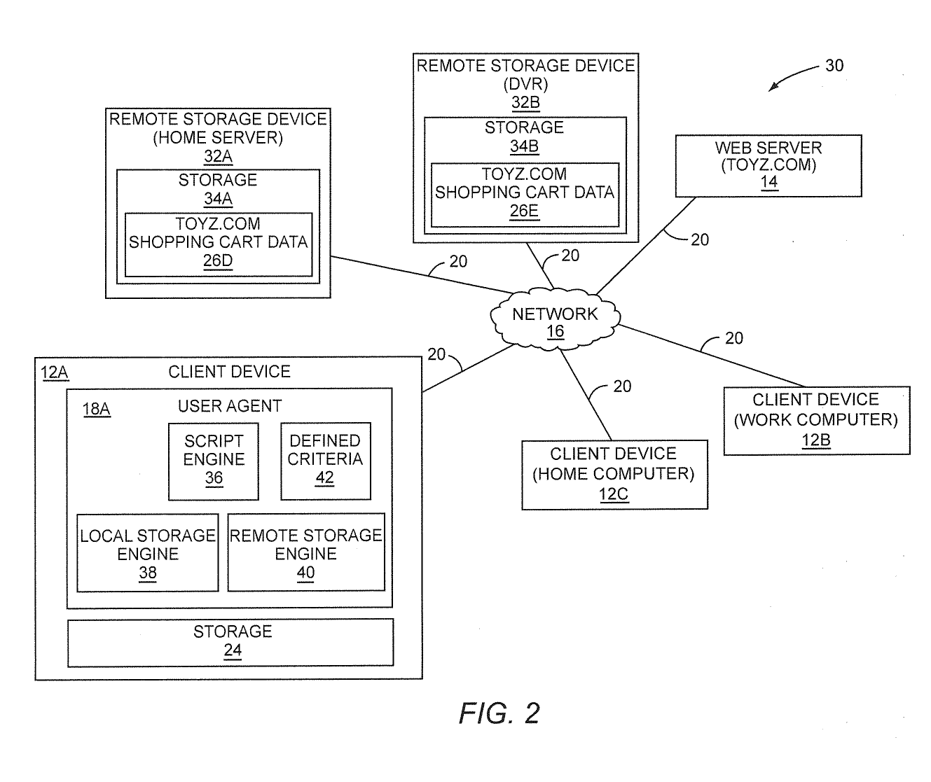

FIG. 2 is a block diagram of a system 30 utilizing the present invention. The system 30 illustrates only the client device 12A in detail for purposes of illustration, but it should be assumed for purposes of this discussion that the client devices 12B and 12C are similarly configured. The system 30 also includes one or more remote storage devices 32, such as remote storage devices 32A and 32B, which are coupled to the network 16 via respective access links 20. One or more of the remote storage devices 32A, 32B may be referred to herein generally as the remote storage device 32 or the remote storage devices 32 where the discussion applies to any remote storage device 32. The remote storage device 32 may comprise any processing device capable of storing, modifying, or otherwise accessing data in a respective storage device 34A, 34B upon request. For example, the remote storage device 32 may comprise a general purpose computer, such as a laptop computer, a desktop computer, a computer server, and the like; or a specialized computing device, such as a DVR, a media server, and the like. The storage devices 34A, 34B may comprise any suitable storage medium, including, for example, a hard disk drive, a flash drive, a USB drive, and the like.

The user agent module 18A includes one or more script engines 36 which process scripts contained or referenced in any HTTP messages received by the user agent module 18A. The script engine 36 may process scripts written in any of various script languages, such as JavaScript, Jscript, or Adobe® Flex. The user agent module 18A may also include a local storage engine 38, which may be used by the user agent module 18A, or a module of the user agent module 18A, such as the script engine 36, to implement client-side storage operations directed to the client-side storage 24. The user agent module 18A may also include a remote storage engine 40 for implementing client-side storage operations on one or more of the remote storage devices 32A, 32B. While the local storage engine 38 and the remote storage engine 40 are illustrated as being separate from the script engine 36, it will be understood that the local storage engine 38 and the remote storage engine 40 could be integral with the script engine 36.

Defined criteria 42 may be maintained in a memory and/or a file. The word “criteria” may be used herein in both the singular and the plural sense, and reference to the word criteria, such as the defined criteria 42, may constitute a reference to a single criterion. The user agent module 18A may use the defined criteria 42 to identify one or more remote storage devices 32 on which a client-side storage operation should be implemented. According to one embodiment of the invention, the user agent module 18A may also use the defined criteria 42 to determine whether a client-side storage operation should be implemented on a remote storage device 32 or, alternatively, whether the client-side storage operation should be implemented on the client-side storage 24. The defined criteria 42 may be maintained in a global location that is accessible to each of the client devices 12A-12C and may be loaded into a memory of the respective client devices 12A-12C when the user agent modules 18A-18C initially load.

The defined criteria 42 can include criteria based on one or more attributes of the HTTP message, the client device 12A to which the HTTP message is addressed, contextual information such as time or date, and the like. Criteria based on one or more attributes of the HTTP message can include, for example, a type of service associated with the HTTP message, a type of data that is the subject of the client-side storage operations contained in the HTTP message, or a source address, such as a domain or URL of the HTTP message. Criteria based on the client device 12A to which the HTTP message is directed can include, for example, an address associated with the client device 12A, a location of the client device 12A, a proximity of the client device 12A to another client device 12, and the like. Location information of a mobile client device 12 may be obtained in any known manner, such as via a location detecting service, or via the service provider providing service to the mobile client device 12.

Assume that a user using the client device 12A directs the user agent module 18A to display the home page of the web service TOYZ.COM, hosted by the web server 14. For example, the user may enter the WWW.TOYZ.COM URL into a URL address field of the user agent module 18A and select “ENTER.” The user agent module 18A initiates an HTTP message to the web server 14 requesting the content of the home page. In response, the web server 14 sends the user agent module 18A, via the client device 12A, an HTTP message which contains data for displaying the home page of the TOYZ.COM web service. The HTTP message may also contain a plurality of client-side storage operations. In particular, assume that the HTTP message includes client-side storage operations which involve opening a database in the client-side storage 24A, retrieving data from the database, and displaying the data to the user on the display 22A (FIG. 1). For example, the data may relate to product information that the user previously saved while browsing the TOYZ.COM web service and saved in a “shopping cart.”

Assume that the defined criteria 42 indicates that client-side storage operations contained in HTTP messages received from the TOYZ.COM web service are to be implemented on the remote storage devices 32A, 32B. Because the client-side storage operations in the HTTP message are read-type storage operations, the user agent module 18A may implement the client-side storage operations on only one of the remote storage devices 32A, 32B. The particular remote storage device 32A or 32B on which to implement read-type storage operations may be indicated during configuration of the user agent module 18A or based simply on which of the remote storage devices 32A, 32B are identified first in the defined criteria 42, for example. Assume that the user agent module 18A implements read-type storage operations on the remote storage device 32A. The user agent module 18A directs the client-side storage operations to the remote storage device 32A, which responds by providing the TOYZ.COM shopping cart data 26D from the storage device 34A. The user agent module 18A may then display the shopping cart data 26D, or a summary of such data, to the user as directed by the instructions in the HTTP message received from the web server 14.

In this manner, the user agent module 18A implements client-side storage operations on the remote storage device 32A in lieu of the client-side storage 24A. One advantage of the present invention may be illustrated by a further example wherein the user, while browsing the TOYZ.COM web service, adds another product to their shopping cart. The user agent module 18A detects the client-side storage operations associated with storing the product information in the client-side storage 24A, determines that the client-side storage operations should be implemented on the remote storage devices 32A, 32B, and implements the client-side storage operations on the remote storage devices 32A, 32B in lieu of the client-side storage 24A. Assume that the user subsequently interrupts their browsing activity. Assume further that the user, perhaps after arriving home in the evening, subsequently uses the client device 12C to access the home page of the TOYZ.COM web service, in a similar manner as described previously. The user agent module 18A receives an HTTP message from the web server 14 and, as described previously, obtains the shopping cart data 26D from the remote storage device 32A. However, in this situation, and in contrast to the example provided with respect to FIG. 1, the data received from the remote storage device 32A includes the product information of the item added to the shopping cart data 26D while browsing the TOYZ.COM web service using the client device 12A. Thus, the present invention enables global storage and management of data that was previously limited to a particular client device 12.

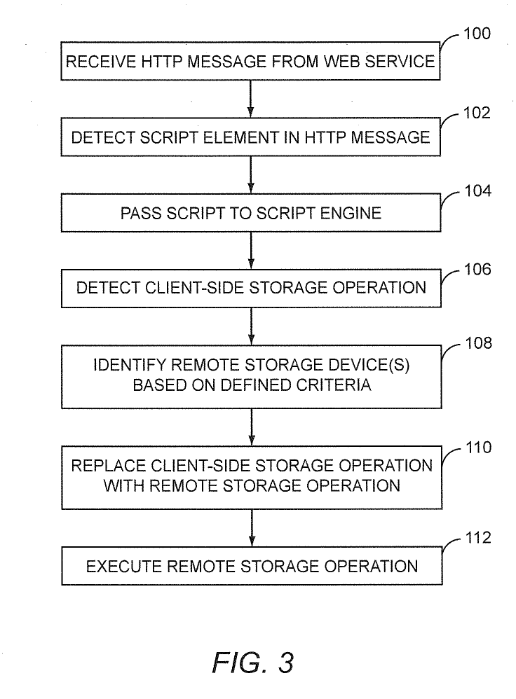

FIGS. 3-6 are flow charts illustrating various methods by which the user agent module 18 may implement client-side storage operations on a remote storage device 32. FIGS. 3-6 will be discussed in conjunction with FIG. 2. Assume again that the user has directed the user agent module 18A to obtain the home page of the TOYZ.COM web service. The web server 14 sends an HTTP message to the user agent module 18A in response to receiving the request from the user agent module 18A from the home page. The HTTP message contains instructions, such as HTML instructions, that, when executed by the user agent module 18A, will cause the home page of the TOYZ.COM web service to be displayed to the user on the display 22A. The user agent module 18A receives the HTTP message (step 100). The HTTP message may be any variant of HTTP, such as HTTP 1.0, HTTP 1.1, or HTTPS, for example. The user agent module 18A detects a script in the HTTP message (step 102). For example, the script may be a JavaScript, a Jscript, an Adobe® Flex script or the like. The script may be actual instructions written in a scripting language or a reference to a script file containing such script instructions. Upon detection of the script, the user agent module 18A passes the script to the script engine 36 for processing (step 104). While only a single script engine 36 is illustrated in FIG. 2, the script engine 36 may be one of several script engines 36 contained in, or coupled to, the user agent module 18A. In particular, the user agent module 18A may contain a separate script engine 36 for each type of script that may be contained in the HTTP message.

According to one embodiment of the invention, the script engine 36 has a script pre-processing phase and a script execution phase. In the script pre-processing phase, the script engine 36 processes the script prior to executing the script instructions. The script engine 36 processes the script to detect any client-side storage operations. For example, the script engine 36 may parse each script instruction to determine if any script instruction is a predetermined client-side storage operation. For example, the script engine 36 may maintain a list of potential client-side storage operations, such as “open,” “read,” “save,” “store,” and the like and may determine if the script contains any such client-side storage operations during the script pre-processing phase. Table 1 contains an exemplary client-side storage operation.

TABLE 1
openDatabase (“Shopping Cart”, “1.0”,“example”,“200000”)

The client-side storage operation “openDatabase” may comprise a function, or method, invocation of a function contained in the local storage engine 38. Assume that the script engine 36 detects the client-side storage operation during the script pre-processing phase (step 106). The script engine 36 may access the defined criteria 42 to determine a particular remote storage device(s) 32 on which the client-side storage operation should be implemented (step 108). The defined criteria 42 may be based on any desired criteria, including a type of service provided by the web service, a source address of the web service, a type of data that is the subject of the client-side storage operation, and the like. Assume that the defined criteria 42 indicates that client-side storage operations associated with HTTP messages from the TOYZ.COM web service are to be implemented on the remote storage devices 32A, 32B. In particular, assume the defined criteria 42 indicates that read-type client-side storage operations should be directed to the remote storage device 32A, and write-type client-side storage operations should be directed to both remote storage devices 32A, 32B.

Based on the defined criteria, the script engine 36 alters the client-side storage operation with a remote storage operation (step 110). For example, the client-side storage operation illustrated in Table 1 may be replaced by the remote storage operation illustrated in Table 2 below.

TABLE 2

remoteStorage_openDatabase (“Shopping Cart”,
“1.0”,“example”,“200000”, “192.168.1.2”)

The remote storage operation illustrated in Table 2 may comprise a function invocation of a function contained in the remote storage engine 40. The function invocation may include various parameters, including the IP address of the remote storage device 32A (e.g., 192.168.1.2). Thus, the script engine 36 has replaced the client-side storage operation with a remote storage operation. Assume that the script engine 36 finishes the script pre-processing phase and enters the script execution phase. The script engine 36 begins executing the script. Upon execution of the remote storage operation illustrated in Table 2, the script engine 36 invokes the “remoteStorage_openDatabase” function of the remote storage engine 40 (step 112). The remote storage engine 40 receives the parameters “(“Shopping Cart”, “1.0”, “example”, “200000”, “192.168.1.2”)” and opens the database containing the TOYZ.COM shopping cart data 26D on the remote storage device 32A.

In an alternative embodiment, rather than using a remote storage engine 40, the script engine 36 may generate additional script instructions for implementing the client-side storage operations on the remote storage device 32A. For example, the script engine 36 may, upon detection of the client-side storage operation illustrated in Table 1, generate new script instructions such as those illustrated in Table 3, below.

TABLE 3

function remoteStorage_openDatabase( var name, var

version, var note, var size ) {
var operation = ″command=openDatabase,name=″ + name +
″,version=″ + version + ″,note=″ + note + ″,size=″ + size;
var remoteStorageLocations = new Array( ″192.168.1.101″,
″192.168.1.102″);
for ( i = 0; i < remoteStorageLocations.length; i++ ) {

var xmlhttp = new XmlHttpRequest( );
xmlhttp.open( “POST”, “http://” + remoteStorageLocations[i]
+ “/remoteDatabase”, false);
xmlhttp.setRequestHeader(″Content-type″, ″application/x-
www-form-urlencoded″);
xmlhttp.setRequestHeader(″Content-length″,
operation.length);
xmlhttp.setRequestHeader(″Connection″, ″close″);
xmlhttp.send( operation );
}

}

In this embodiment, the client-side storage operation “openDatabase (“Shopping Cart”, “1.0”, “example”, “200000”)” is still replaced with the function call illustrated in Table 2, but upon execution during the script execution phase, the script function illustrated in Table 3 is invoked rather than a function in the remote storage engine 40.

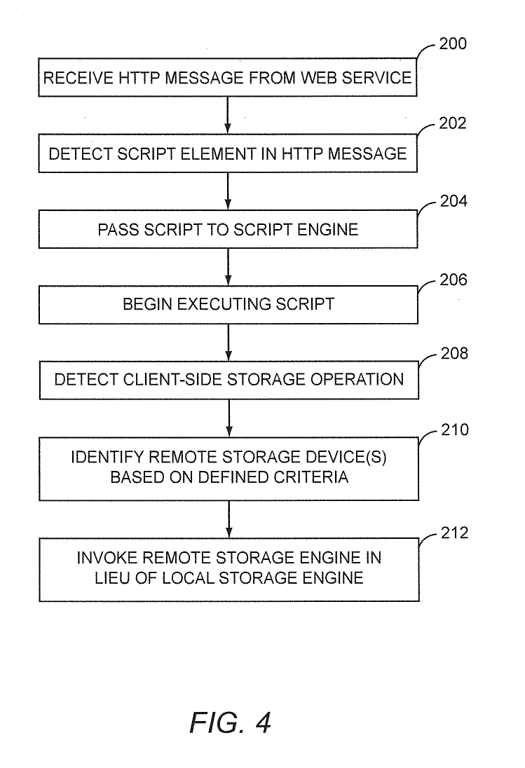

FIG. 4 is a flow chart illustrating a method for implementing client-side storage operations on a remote storage device 32 according to another embodiment of the invention. Steps 200, 202, and 204 are similar to those described with respect to steps 100, 102, and 104, respectively, of FIG. 3 and will not be discussed in detail herein. However, in this embodiment, the script engine 36 does not have a separate script pre-processing phase and begins to execute the script commands (step 206). Prior to executing each script command, the script engine 36 determines if the script command is a client-side storage operation (step 208). The script engine 36 may determine this in a manner similar to that described with respect to step 106 of FIG. 3. Upon detection of a client-side storage operation, the script engine 36 may access the defined criteria 42 (step 210), in a manner similar to that described with respect to step 108 of FIG. 3, to determine whether the client-side storage operation should be replaced with a remote storage operation. However, in this embodiment, rather than replace the script command, the script engine 36 invokes a desired entry point into the remote storage engine 40 to implement the client-side storage operation on the remote storage device 32. For example, assume that the script engine 36 detects the client-side storage operation illustrated in Table 1, above. After accessing the defined criteria 42, the script engine 36 may simply invoke the remote storage engine 40 by invoking the “remoteStorage_openDatabase” entry point through an invocation such as that illustrated in Table 2 (step 212).

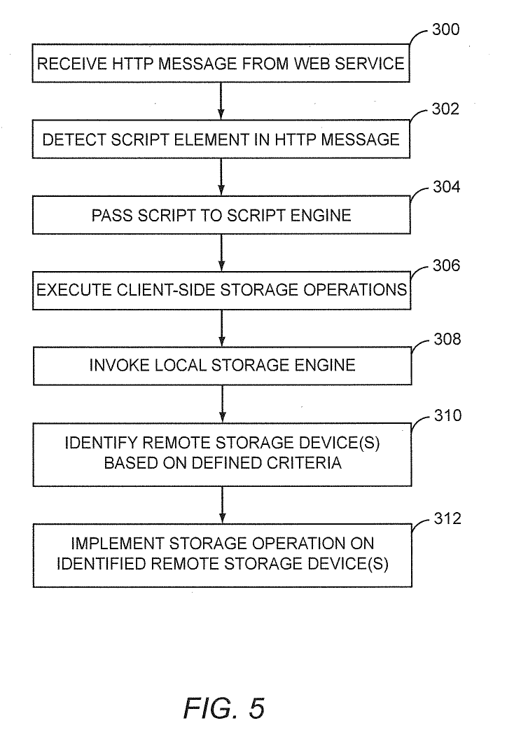

FIG. 5 is a flow chart illustrating a method for implementing client-side storage operations on a remote storage device 32 according to another embodiment of the invention, wherein a remote storage engine 40 is not used. Steps 300, 302, and 304 are similar to those described with respect to steps 100, 102, and 104, respectively, of FIG. 3 and will not be discussed in detail herein. In this embodiment, the script engine 36 executes the script without first determining whether the script instructions include client-side storage operations (step 306). Upon execution of a client-side storage operation, the local storage engine 38 is invoked (step 308). The local storage engine 38 accesses the defined criteria 42 to determine whether the client-side storage operation should be implemented on a remote storage device 32, in a manner similar to that described with respect to step 108 of FIG. 3 (step 310). If so, the local storage engine 38 implements the client-side storage operation on the remote storage device 32 (step 312).

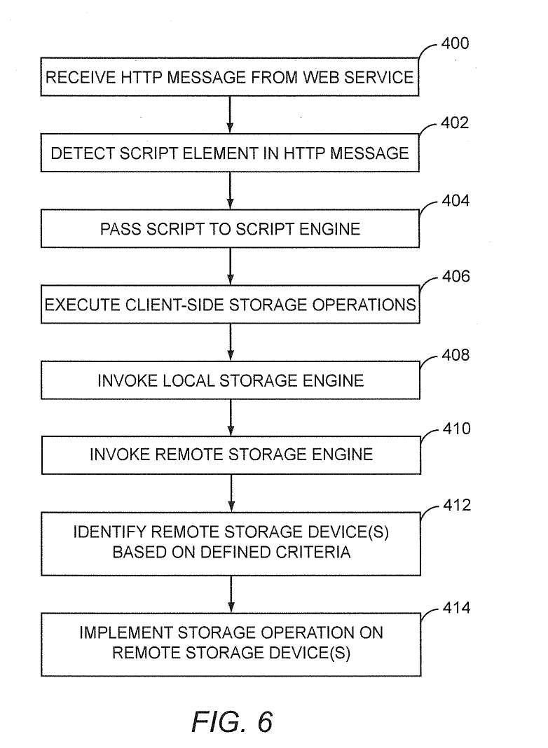

FIG. 6 is a flow chart illustrating a method for implementing client-side storage operations on a remote storage device 32 according to another embodiment of the invention. Steps 400, 402, 404, 406, and 408 are similar to those described with respect to steps 300, 302, 304, 306, and 308, respectively, of FIG. 5 and will not be discussed in detail herein. In this embodiment, however, the local storage engine 38 merely invokes the remote storage engine 40 (step 410). The remote storage engine 40 then accesses the defined criteria 42 in a manner similar to that described with respect to step 108 of FIG. 3 (step 412). The remote storage engine 40 then implements the client-side storage operation on the remote storage device 32 (step 414). The remote storage engine 40 may implement the client-side storage operation on the remote storage device 32 in any suitable manner. For example, the remote storage engine 40 may communicate with the remote storage device 32 using Transmission Control Protocol/Internet Protocol (TCP/IP), HTTP, or some other communication protocol. The communication may be in the form of remote procedure calls, Simple Object Access Protocol (SOAP) based web services, Representational State Transfer (REST) or RESTful based web services, or the like. The communication may be synchronous or asynchronous, and may require credentials or other security mechanism to ensure secure communications with the remote storage device 32.

According to one embodiment of the invention, the defined criteria 42 may be based on contextual information to determine whether or not to implement client-side storage on a remote storage device. In such an embodiment, a synchronization mechanism may be used to ensure that data contained in client-side storage locations, such as the client-side storage 24, is periodically synchronized with remote storage devices 32.

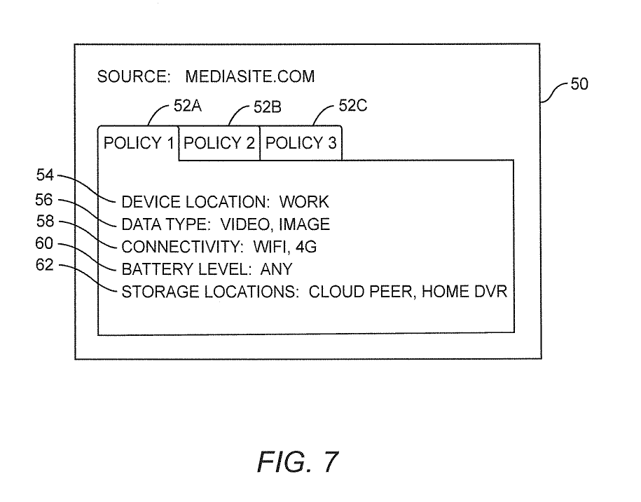

FIG. 7 is a block diagram illustrating an exemplary user interface window 50 that may be used to define the defined criteria 42 used by the user agent module 18 to determine whether client-side storage operations should be implemented on a remote storage device 32, and if so, upon which particular remote storage device(s) 32 the operations should be implemented. In this example, the defined criteria 42 relates to a web service “MEDIASITE.COM.” The user interface window 50 may include a plurality of policy tabs 52A-52C. For purposes of illustration, the contents of only the policy tab 52A are shown in FIG. 7. The policy tab 52A may include defined criteria including a device location identifier 54, a data type identifier 56, a connectivity type identifier 58, and a battery level identifier 60. The policy tab 52A may also include a remote storage device identifier 62, which identifies the particular remote storage devices 32 to which the remote storage instructions should be sent. The device location identifier 54 may identify, for example, a work location, a home location, and the like. As discussed previously, the user agent module 18 may obtain a current location of the client device 12 in any conventional or proprietary manner, including, for example, via a location detection service, information provided by a service provider, and the like.

The data type identifier 56 may identify a type of data that is the subject of the client-side storage operations, such as video data, image data, and the like. For example, based on the criteria illustrated in FIG. 7, the client-side storage operations may be replaced with remote storage instructions only if the data type of the data associated with the client-side storage operations is a video type or an image type. The connectivity type identifier 58 may identify a type of connection used by the client device 12 such as WiFi or 4G. Thus, client-side storage operations may be implemented on a remote storage device only when the connectivity of the client device 12A is WiFi connectivity or 4G connectivity.

The battery level identifier 60 can indicate a battery level threshold. For example, if a battery level of the client device 12 is below an identified threshold, the client-side storage operation will be implemented on a remote storage device, but if the battery level of the client device 12 is above the identified threshold, the client-side storage operations will not be implemented on a remote storage device. Those of skill in the art will recognize the identifiers 54-60 are merely exemplary.

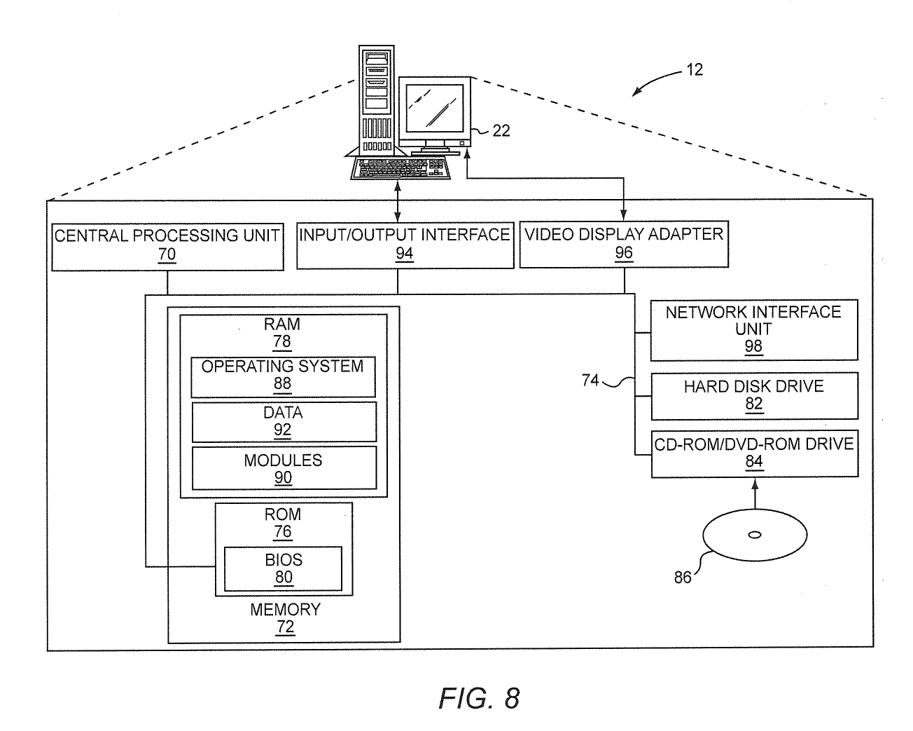

FIG. 8 illustrates components of an exemplary client device 12. The exemplary client device 12 includes a central processing unit 70, system memory 72, and a system bus 74. The system bus 74 provides an interface for system components including, but not limited to, the system memory 72, to the central processing unit 70. The central processing unit 70 can be any of various commercially available processors. Dual microprocessors and other multi-processor architectures may also be employed as the central processing unit 70.

The system bus 74 can be any of several types of bus structures that may further interconnect to a memory bus (with or without a memory controller), a peripheral bus, and a local bus using any of a variety of commercially available bus architectures. The system memory 72 can include non-volatile memory 76 and/or volatile memory 78 (e.g., random access memory (RAM)). A basic input/output system (BIOS) 80 can be stored in the non-volatile memory 76 (e.g., ROM, EPROM, EEPROM, etc.), which can include the basic routines that help to transfer information between elements within the client device 12. The volatile memory 78 can also include a high-speed RAM such as static RAM for caching data.

The client device 12 may further include an internal hard disk drive (HDD) 82 (e.g., enhanced integrated drive electronics (EIDE) or serial advanced technology attachment (SATA)) for storage. The internal HDD 82 may also be configured for external use in a suitable chassis, such as an optical disk drive 84 (e.g., reading a compact disc read-only memory (CD-ROM) disk 86). The drives and associated computer-readable media provide non-volatile storage of data, data structures, computer-executable instructions, and so forth. For the client device 12, the drives and media accommodate the storage of any data in a suitable digital format. Although the description of computer-readable media above refers to a HDD and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, any such media may contain computer-executable instructions for performing novel methods of the disclosed architecture.

A number of program modules can be stored in the drives and volatile memory 78 including an operating system 88; one or more application modules 90 including, for example, the user agent module 18, the script engine 36, the local storage engine 38, and the remote storage engine 40, and other program modules. All or portions of the operating system 88, applications, modules, and/or data 92 can also be cached in the volatile memory 78. It is to be appreciated that the disclosed architecture can be implemented with various commercially available operating systems or combinations of operating systems. All or a portion of the invention may be implemented as a computer program product, such as a computer usable medium having a computer readable program code embodied therein. The computer readable program code can include software instructions for implementing the functionality of the user agent module 18 and other aspects of the present invention, as discussed herein.

A user can enter commands and information into the client device 12 through one or more wired/wireless input devices, for example, a keyboard and a pointing device, such as a mouse (not illustrated). Other input devices (not illustrated) may include a microphone, an infrared (IR) remote control, a joystick, a game pad, a stylus pen, touch screen, or the like. These and other input devices are often connected to the central processing unit 70 through an input device interface 94 that is coupled to the system bus 74 but can be connected by other interfaces such as a parallel port, an IEEE 1394 serial port, a game port, a USB port, an IR interface, etc.

The client device 12 may include the display 22, which may also be connected to the system bus 74 via an interface, such as a video adapter 96. The client device 12 may operate in a networked environment using a wired and/or wireless communication network interface or adapter 98. The adapter 98 can facilitate wired and/or wireless communications to the network 16 (FIG. 1).

The client device 12 may be operable to communicate with any wireless devices or entities operatively disposed in wireless communication, for example, a printer, a scanner, a desktop and/or portable computer via wireless technologies, such as Wi-Fi and Bluetooth, for example.

Those skilled in the art will recognize improvements and modifications to the preferred embodiments of the present invention. All such improvements and modifications are considered within the scope of the concepts disclosed herein and the claims that follow.

What is claimed is:

1. A method for redirecting client-side storage operations to a remote storage device, comprising:
receiving, by a user agent module executing on a client device, a hypertext transfer protocol (HTTP) message comprising a client-side storage operation directed to a client storage device;
detecting, by the user agent module, the client-side storage operation; and
implementing, by the user agent module, the client-side storage operation on the remote storage device in lieu of the client storage device.

2. The method of claim 1, wherein the client storage device comprises a hard drive that is integral with the client device.

3. The method of claim 2, wherein the client device is a computer.

4. The method of claim 1, wherein the user agent module further comprises a local storage engine and a remote storage engine, and wherein the client-side storage operation comprises a reference to the local storage engine, further comprising replacing the reference to the local storage engine with a reference to the remote storage engine.

5. The method of claim 4, wherein the user agent module further comprises a JavaScript engine, and the replacing the reference step is performed by the JavaScript engine.

6. The method of claim 5, wherein the JavaScript engine comprises a script pre-processing phase and a script execution phase, and wherein the replacing the reference step is performed during the script execution phase.

7. The method of claim 1, wherein the user agent module further comprises a local storage engine and a remote storage engine, wherein the client-side storage operation comprises a reference to the local storage engine, and wherein implementing the client-side storage operation on the remote storage device comprises invoking the remote storage engine in lieu of the local storage engine.

8. The method of claim 7, wherein the user agent module further comprises JavaScript engine, and wherein the invoking the remote storage engine step is performed by the JavaScript engine.

9. The method of claim 1, wherein the user agent module further comprises local storage engine and remote storage engine, and wherein implementing the client-side storage operation comprises calling the remote storage engine from the local storage engine.

10. The method of claim 1, further comprising identifying the remote storage device from a plurality of remote storage devices based on a defined criteria.

11. The method of claim 10, wherein the defined criteria comprises a type of service identified in the HTTP message.

12. The method of claim 10, wherein the defined criteria comprises a type of data associated with the client-side storage operation.

13. The method of claim 10, wherein the defined criteria comprises a source of data associated with the client-side storage operation.

14. An apparatus comprising:
a communications interface adapted to communicate with a network; and
a user agent module coupled to a control system coupled to the communications interface and adapted to:
receive, by a user agent module executing on a client device, a hypertext transfer protocol (HTTP) message comprising a client-side storage operation directed to a client storage device;
detect, by the user agent module, the client-side storage operation; and
implement, by the user agent module, the client-side storage operation on a remote storage device in lieu of the client storage device.

15. A computer program product comprising a computer usable medium having a computer readable program code embodied therein, the computer readable program code adapted to be executed to implement a method for redirecting client-side storage operations to a remote storage device, the method comprising:
receiving, by a user agent module executing on a client device, a hypertext transfer protocol (HTTP) message comprising a client-side storage operation directed to a client storage device;
detecting, by the user agent module, the client-side storage operation; and
implementing, by the user agent module, the client-side storage operation on the remote storage device in lieu of the client storage device.

16. The computer program product of claim 15, wherein the user agent module further comprises a local storage engine and a remote storage engine, and wherein the client-side storage operation comprises a reference to the local storage engine, and wherein the method further comprises replacing the reference to the local storage engine with a reference to the remote storage engine.

17. The computer program product of claim 16, wherein the user agent module further comprises a JavaScript engine, and the replacing the reference step is performed by the JavaScript engine.

18. The computer program product of claim 17, wherein the JavaScript engine comprises a script pre-processing phase and a script execution phase, and wherein the replacing the reference step is performed during the script execution phase.

19. The computer program product of claim 15, wherein the user agent module further comprises a local storage engine and a remote storage engine, wherein the client-side storage operation comprises a reference to the local storage engine, and wherein implementing the client-side storage operation on the remote storage device comprises invoking the remote storage engine in lieu of the local storage engine.
